(19) United States
(12) Patent Application Publication
(10) Pub. No.: US 2018/0025476 A1
(43) Pub. Date: Jan. 25, 2018

(54) APPARATUS AND METHOD FOR PROCESSING IMAGE, AND STORAGE MEDIUM

(71) Applicant: CANON KABUSHIKI KAISHA, Tokyo (JP)

(72) Inventor: Takashi Akahane, Tokyo (JP)

(21) Appl. No.: 15/650,581

(22) Filed: Jul. 14, 2017

(30) Foreign Application Priority Data
Jul. 21, 2016 (JP) 2016-143698

(51) Int. Cl. G06T 5/00; G06T 11/00; G06T 1/00; G06T 11/80

(52) U.S. Cl. CPC G06T 5/008; G06T 11/80; G06T 11/001; G06T 1/0007; H04N 2101/00

(57) ABSTRACT

An image processing apparatus includes a range-information acquisition unit configured to acquire range information on an input image, a gradation assigning unit configured to assign a gradation to each area of the input image using the range information and to convert luminance data on the input image according to the assigned gradation, a representative-color setting unit configured to set a representative color, and a toning unit configured to convert color data on the input image according to the representative color.

### BACKGROUND

### Field of the Disclosure

The present disclosure generally relates to image processing and, more particularly, to an apparatus and method for processing an image, a storage medium, and an image processing technique for giving a shadow-tone effect to digital image data.

### Description of the Related Art

There is image processing for emphasizing the silhouette of an object by reducing the amount of information in input image data. In one example, a known image processing apparatus includes an image processing circuit that generates a cutout-picture image by performing fill-in processing on the basis of an outline extracted from input image data (for example, see Japanese Patent Laid-Open No. 2011-180643). In another example, an image is spatially grouped by similar colors, and the same group is expressed in one color, so that the number of colors used is reduced. There is a method for expressing the taste of a watercolor picture painted with limited number of paints by the above method (for example, see Japanese Patent Laid-Open No. 11-232441).

However, since the processing disclosed in Japanese Patent Laid-Open No. 2011-180643 is premised on black-and-white images and takes no thought for processing color information, it is difficult to form a color image. With the method disclosed in Japanese Patent Laid-Open No. 11-232441, a color image in which the color of an input image is drawn can be formed. However, when the background and the main object with similar colors overlap front and rear, the background the main object can be expressed in the same color. For that reason, it is difficult to form a shadow-tone image composed of a color background and a black or gray main object.

### SUMMARY

One or more aspects of the disclosure is an image processing apparatus that includes a range-information acquisition unit configured to acquire range information on an input image, a gradation assigning unit configured to assign a gradation to each area of the input image using the range information and to convert luminance data on the input image according to the assigned gradation, a representative-color setting unit configured to set a representative color, and a toning unit configured to convert color data on the input image according to the representative color.

Another disclosed aspect of the disclosure is a method for processing an image. The method includes acquiring range information on an input image, assigning a gradation to each area of the input image using the range information and converting luminance data on the input image according to the assigned gradation, setting a representative color, and converting color data on the input image according to the representative color.

Further features of the present disclosure will become apparent from the following description of exemplary embodiments with reference to the attached drawings.

### BRIEF DESCRIPTION OF THE DRAWINGS

FIG. 1 is a block diagram of an image processing apparatus according to a first embodiment of the present disclosure.

FIG. 2 is a block diagram illustrating the configuration of a shadow-tone processing unit according to the first embodiment.

FIGS. 3A to 3D are diagrams illustrating the input and output characteristics of LUTs for use in gradation assignment according to the first embodiment.

FIGS. 4A to 4F are image diagrams of images subjected to individual processes at the steps of a shadow-tone process according to the first embodiment.

FIG. 5 is a schematic diagram illustrating the relationship between the objects and the distances according to the first embodiment.

FIGS. 6A to 6D are flowcharts illustrating the operations of the shadow-tone process according to the first embodiment.

FIG. 7 is a block diagram illustrating the configuration of a shadow-tone processing unit according to a second embodiment of the present disclosure.

FIGS. 8A and 8B are flowcharts illustrating the operations of a LUT selecting process according to the second embodiment.

FIGS. 9A to 9D are image diagrams of images subjected to a shadow-tone process according to the second embodiment.

FIG. 10 is a graph showing the saturation control characteristic of the toning process according to the first embodiment.

### DESCRIPTION OF THE EMBODIMENTS

Hereinafter, exemplary embodiments of one or more aspects the present disclosure will be described in detail with reference to the attached drawings. However, dimensions, materials, and shapes of components described in the following embodiments and relative arrangements thereof should be appropriately changed depending on the configuration of an apparatus to which the present disclosure is applied and various conditions, and do not intend to limit the scope of the present disclosure to the following embodiments.

### First Embodiment

A first embodiment of the present disclosure will be described hereinbelow.

In the present embodiment, an image processing apparatus including an image capturing system, such as a digital cameras or a scanner, is taken as an example of an image processing apparatus to which the present disclosure can be applied. However, this is given for mere illustration and is not intended to limit the present disclosure. The present disclosure may be applied to the configuration of any other image processing apparatuses that can process image data. In other words, the image processing apparatus may be an image processing apparatus, such as a personal computer, a potable information terminal, or an image forming apparatus, such as a printer. This also applies to the following embodiments.

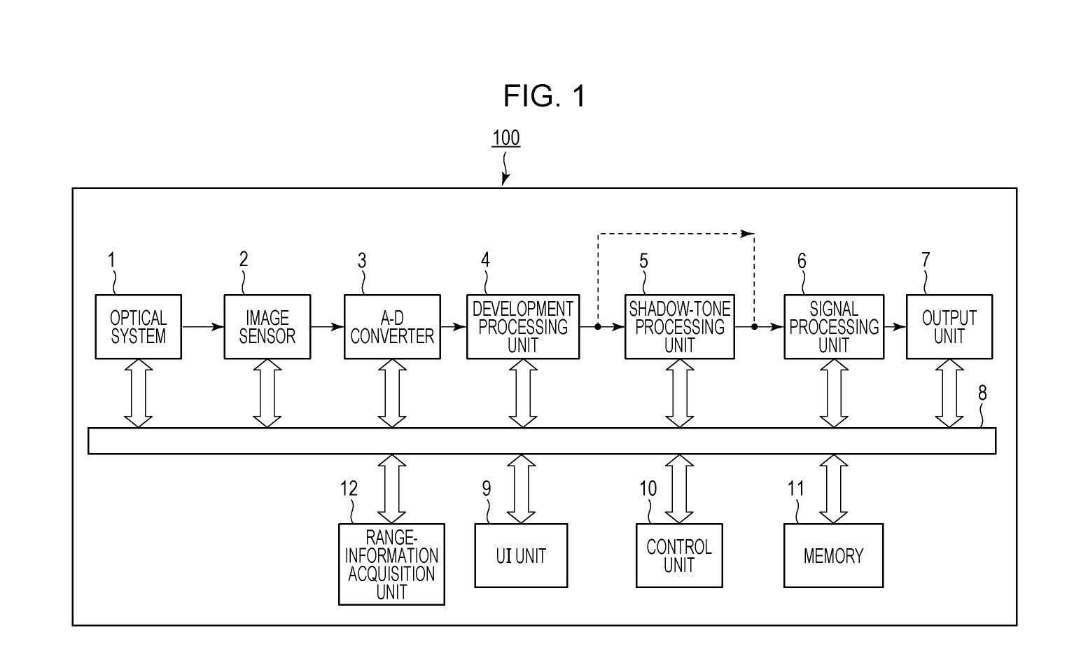

FIG. 1 is a block diagram of a digital camera which is an example of an image processing apparatus 100 of the present embodiment.

In the image processing apparatus 100, object light is focused on an image sensor 2 by an optical system 1 including a diaphragm and a lens, is photoelectrically converted to an electrical signal, and is output from the image sensor 2. An example of the image sensor 2 is a general single-chip color image sensor including a primary color filter. The primary color filter includes three kinds of color filter having main transmission wavelength bands around 650 nm, 550 nm, and 450 nm, which respectively form color planes corresponding to the wavelength bands of R (red), G (green), and B (blue). In the single-chip color image sensor, the color filters are spatially arrayed in a mosaic pattern, and each pixel has an intensity in a single color plane, so that a color mosaic image is output from the image sensor 2.

An analog-to-digital (A-D) converter 3 converts the electrical signal output from the image sensor 2 to a digital image signal and outputs the digital image signal to a development processing unit 4. In this embodiment, 12-bit image data is generated for each pixel at that point in time. The development processing unit 4 performs a series of developing processes including a pixel interpolation process, a luminance signal process, and a color signal process on the digital image signal. In this embodiment, in the process of the development processing unit 4, the RGB color space is converted to a color space of 8-bit luminance (Y) data and chrominance (U, V) data, and YUV data is output from the development processing unit 4.

A range-information acquisition unit 12 acquires range information on the object in the image data output from the development processing unit 4 for each pixel. The range information in the present embodiment may be a relative distance from the in-focus position of the image to the object or an absolute distance from the image capturing apparatus to the object at the time of image capture. The absolute distance and the relative distance may be either a distance on the image plane side or a distance on the object side. The distance may be expressed as either a distance in a real space or a defocus amount.

In the present embodiment, the range-information acquisition unit 12 acquires the range information on the object from the image data output from the development processing unit 4. For acquiring the range information, any known technique, such as a method using imaging-plane phase-difference pixels disclosed in Japanese Patent Laid-Open No. 2000-156823 or a method using differently blurred image data that is taken a plurality of times under different image capture conditions (a depth-from-defocus method [DFD method]) may be used.

However, this is given for mere illustration and is not intended to limit the present disclosure. For example, the range information may be acquired using a phase-difference detecting device without using the image data output from the development processing unit 4.

In the present embodiment, in the case of a photographing mode for performing a shadow-tone process on the photographed image, the image data output from the development processing unit 4 is subjected to a shadow tone process, described later, by a shadow-tone processing unit 5.

A signal processing unit 6 performs a resizing process etc. on the image data subjected to the shadow tone process and supplies the image data to an output unit 7. The output unit 7 performs at least one of outputting the image data to an output interface, such as High Definition Multimedia Interface (HDMI) (a registered trademark), storing the image data in a storage medium, such as a semiconductor memory card, and outputting the image data to a display unit (not shown) of the image processing apparatus 100.

In a normal photographing mode, the image data output from the development processing unit 4 is not subjected to the shadow-tone process and is directly input to the signal processing unit 6, as indicated by the dashed line.

A user interface (UI) unit 9 includes at least one input device, such as a switch, a button, or a touch panel provided on the display unit (not shown). External operations, such as user instructions, are input to the image processing apparatus 100 via the UI unit 9. In response to the inputs, a control unit 10 performs operations or controls the components. The UI unit 9 may be used to select a photographing mode between a shadow toning mode for the shadow-tone process and the normal mode.

The control unit 10 controls the individual components via a bus 8 and performs arithmetic processing as appropriate.

The memory 11 stores image data for use in the individual processing units and data on photographic information, such as f/number, a shutter speed, an ISO (International Organization for Standardization) speed, a white balance gain value, and settings on color gamut, such as s-RGB. The stored data is read according to instructions of the control unit 10 and used as appropriate. The components illustrated in FIG. 1 are connected via the bus 8 so as to communicate with each other.

The units described throughout the present disclosure are exemplary and/or preferable modules for implementing processes described in the present disclosure. The modules can be hardware units (such as one or more processors, one or more memories, circuitry, a field programmable gate array, a digital signal processor, an application specific integrated circuit or the like) and/or software modules (such as a computer readable program or the like). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure.

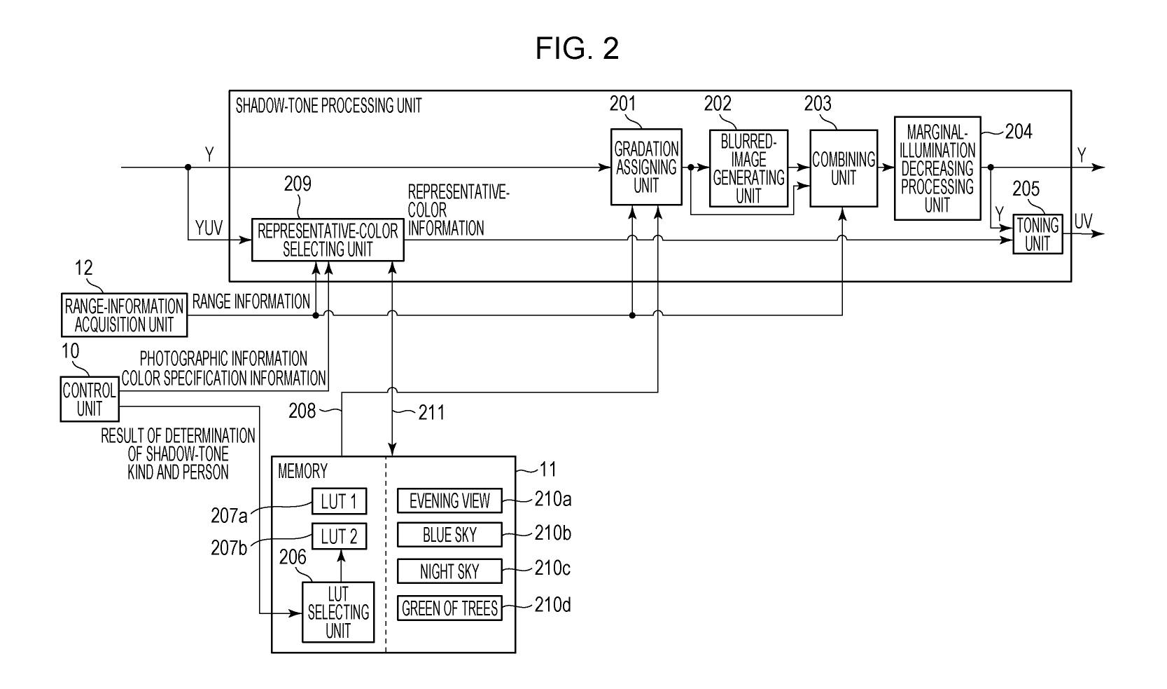

Referring to FIG. 2, a method for image processing in the shadow-tone process executed by the image processing apparatus 100 and the configuration of an image processing circuit that implements the method will be described.

The shadow-tone processing unit 5 has a configuration for providing the characteristics of shadow pictures to image data as an image effect. Typical characteristics of shadow pictures are silhouette expression in which the inside of an outline is filled with black, the amount of blur corresponding to a distance from the screen, a greatly dimmed periphery, and a limited number of colors.

The present embodiment can produce the effect of a shadow picture having a background of rich color in which the atmosphere of the input image is left by creating luminance (Y) data and chrominance (UV) data using different methods from distance to distance using range information corresponding to the photographed image.

A gradation assigning unit 201 assigns gradations to the luminance (Y) data in YUV-format image data input from the development processing unit 4. In the present embodiment, the gradations are assigned on the basis of the range information input from the range-information acquisition unit 12 using a one-dimensional look-up table (LUT).

As illustrated in FIG. 2, the LUT 207 includes a plurality of LUTs (a LUT 207a and a LUT 207b) having different characteristics, which are selected by a LUT selecting unit 206 on the basis of a shadow-tone kind and a face detection result (the result of person detection). The shadow-tone kind will be described later.

A blurred-image generating unit 202 generates a blurred image by performing a blurring process (smoothing process) on the luminance (Y) data to which shadow-tone gradations are assigned by a filtering process using a low pass filter or the like. The blurred image is an image in which the input image is blurred, that is, high frequency components higher than a predetermine frequency is excluded. There are several methods for performing the blurring process, for example, a method of smoothing the image at a time applying a low pass filter with Gaussian filter coefficient in length and width.

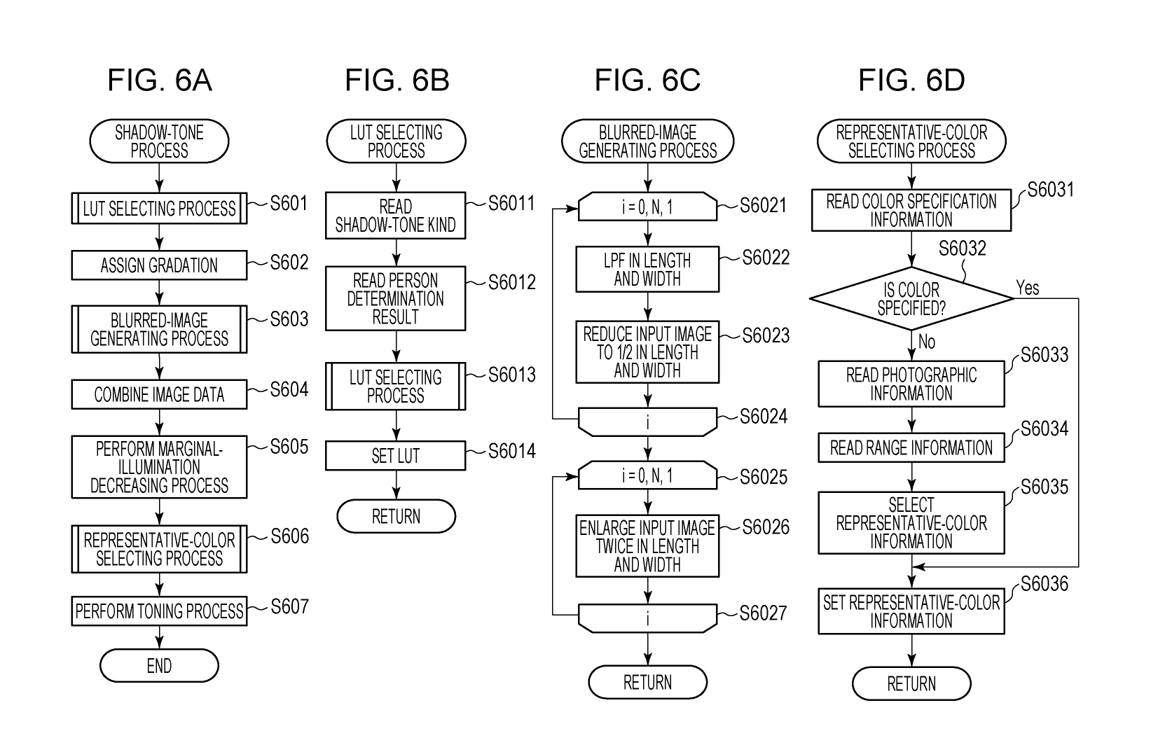

To achieve a blur level desired for the shadow-tone process by one smoothing process, the kernel size of the low pass filter has to be large, which will lead to an enormous processing time. In other words, this is not realistic for the hardware of a camera. For that reason, the present embodiment generates a blurred image by combining a reduction processing circuit and an enlargement processing circuit to reduce the processing time and to acquire a desired blur. The detailed operation of the blurred-image generating process will be described later with reference to the flowchart of FIG. 6C.

A combining unit 203 combines the luminance (Y) data input from the gradation assigning unit 201 and the blurred image input from the blurred-image generating unit 202 under specific conditions. While shadow pictures can be viewed by placing an object that creates a shadow between a screen and a light source and displaying the shadow of the object on the screen, the shadow pictures have the characteristic that the sharpness of the outline changes according to the distance between the object and the screen. In the present embodiment, the combining unit 203 replaces an area in which the range information input from the range-information acquisition unit 12 is a specific value or more with a blurred image, so that the characteristic of a shadow picture in which the amount of blur changes according to the distance from the screen can be given as an image effect.

A marginal-illumination decreasing processing unit 204 performs a process for producing an effect as if the marginal illumination is decreased to image data to which the shadow-tone blur effect is given. To create a clear shadow, a point light source is used to irradiate the object that produces the shadow and the screen. Therefore, shadow pictures have the characteristic that one point on the screen is brightest and is decreased in brightness with an increasing distance from the point.

To give this characteristic to the image data, the present embodiment performs a process for reducing the marginal luminance of the image data, with the center of the screen brightest. Specifically, the luminance distribution of the image data is adjusted by multiplying the image data by marginal-luminance decreasing data (marginal-illumination decreasing data) of two-dimensional distribution corresponding to the image data. The process for reducing the marginal luminance of the image data is given for mere illustration. Luminance decreasing data for adjusting the luminance distribution by performing division, addition, or subtraction on the image data may be used. Alternatively, a method for adjusting the luminance distribution of the image data by calculation without using the luminance decreasing data may be applied to the present disclosure regardless of the method of calculation. Note that the brightest point may be disposed not at the center of the screen but above, below, or outside the screen to express a light source object, such as the sun. In that case, the image data may be multiplied by the marginal-illumination decreasing data after the coordinates of the marginal-illumination decreasing data is shifted vertically and laterally.

The processes performed by the combining unit 203 and the marginal-illumination decreasing processing unit 204 are processes for giving the shadow-tone effect more effectively and are not absolutely necessary to produce the effect of the present disclosure.

A representative-color selecting unit 209 creates representative-color information for toning a shadow-tone image. Although basic shadow pictures are black and white monotone because they are produced by applying light, which is perceived as colorless by human eyes, to a colorless screen from an incandescent lamp, an LED bulb, or a projector light source, the shadow pictures may be toned by placing a color film in front of the light source to express sky blue or sunset red. To give this effect to the image data, the present embodiment performs representative-color-information selecting process corresponding to color film selection in an actual shadow picture using the representative-color selecting unit 209.

A toning unit 205 creates chrominance (UV) data on the shadow-tone image using the luminance (Y) data and the representative-color information subjected to the marginal-illumination decreasing process.

The shadow-tone processing unit 5 outputs a combination of the luminance (Y) data output from the marginal-illumination decreasing processing unit 204 and the chrominance (UV) data output from the toning unit 205 to the signal processing unit 6 as YUV-image data.

The gradation assigning process performed by the gradation assigning unit 201 in the present embodiment will be described in detail.

The gradation assigning unit 201 assigns gradations to the image data according to the range information input from the range-information acquisition unit 12. However, various forms are assumed for the range information as described above. Therefore, the range information may not be directly used to assign gradations to the image data. For that reason, the present embodiment stores a LUT matching the form of the range information in the memory 11 and assigns the result of application of the LUT to the range information as the gradations for the image data.

The present embodiment uses range information in which the object distance of each pixel in the image data is expressed in 256-step gradation, an infinite distance at 0, a focal plane at 128, and the closest end at 255.

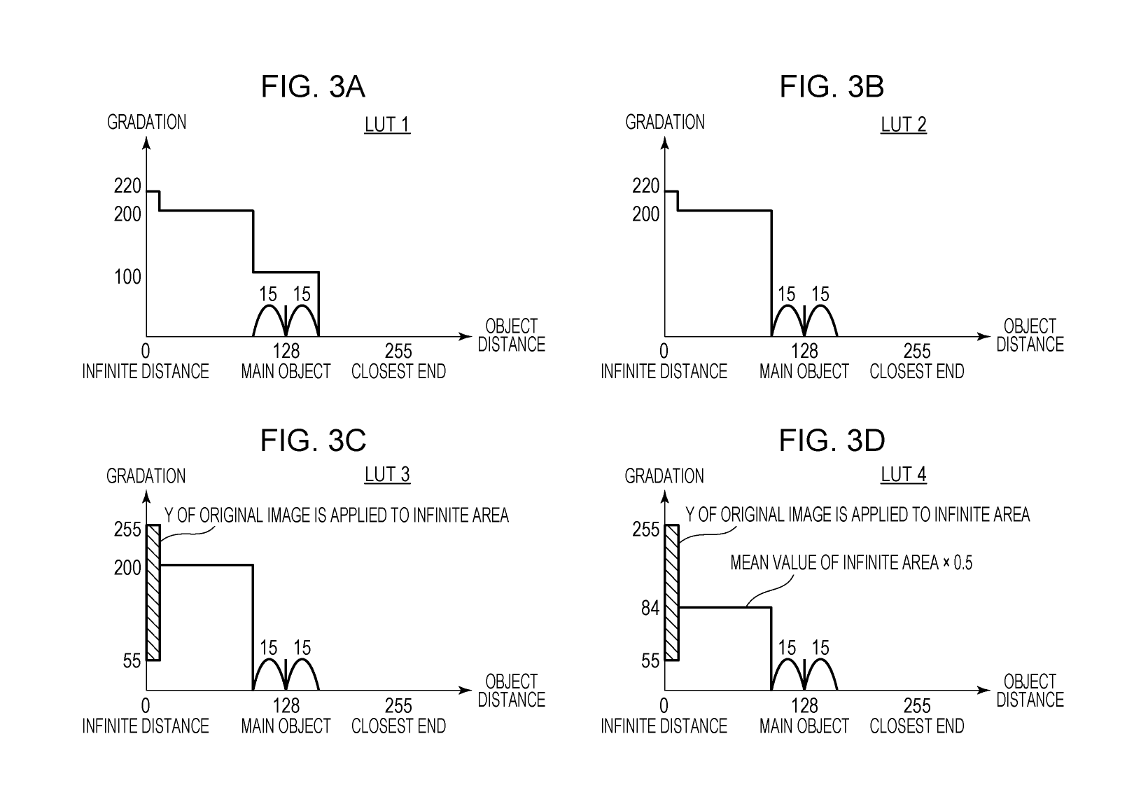

FIG. 3A illustrates the characteristic of the LUT 207a (LUT 1) for converting the above-described range information to shadow tone gradations. Shadow pictures have the gradation characteristics that the entire main object is dark (black) with a shadow, the distant view is somewhat bright as contrasted with the shadow, and an area in which no object is present is brightest (white) because it is a screen that shows the shadow picture. The reason why the distant view in the shadow picture is brighter than the shadow is that the object forming the shadow is far from the screen and is close to the light source, so that the light from the light source wraps around the object.

To provide gradations with which the silhouette of the main object on the focal plane can be clearly distinguished, the LUT 207a is configured such that, with respect to 128 that indicates a focal plane, inputs within the range between 128−15 and 128+15, which is regarded as a main object area, are given a gradation value 100 indicating the main object, inputs greater than 128+15 are regarded as closest end objects and are given a gradation value 0 indicating a shadow, inputs less than 128−15 are regarded as infinite distance objects and are given a gradation value 220 indicating the screen, and the other inputs are regarded as distant objects and are given a gradation value 200 indicating a distant view.

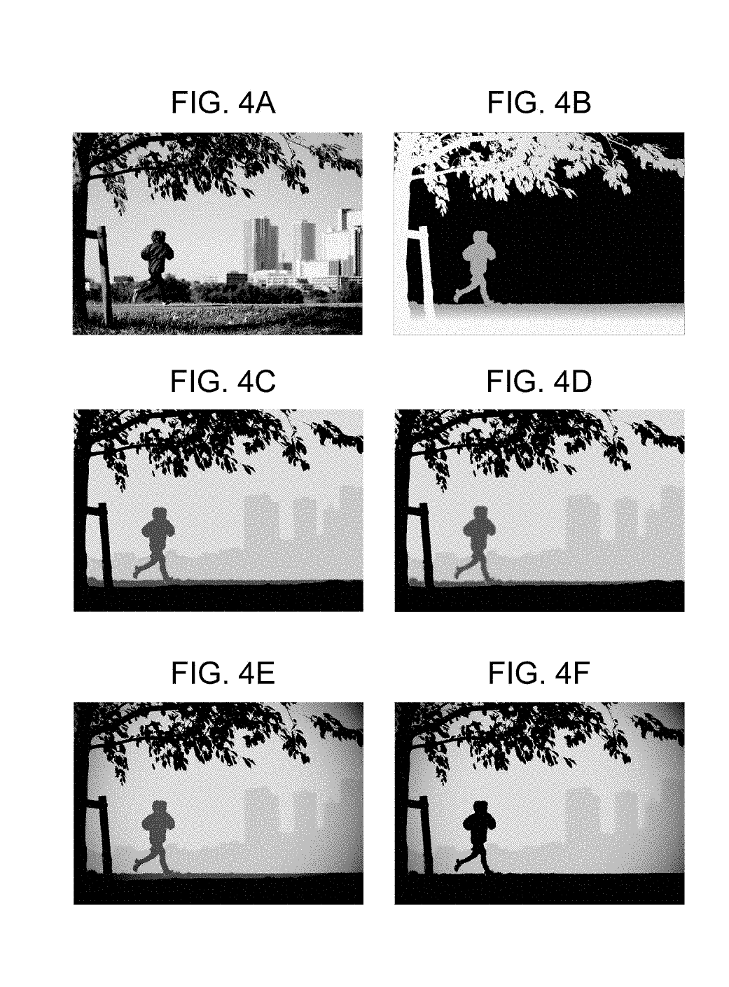

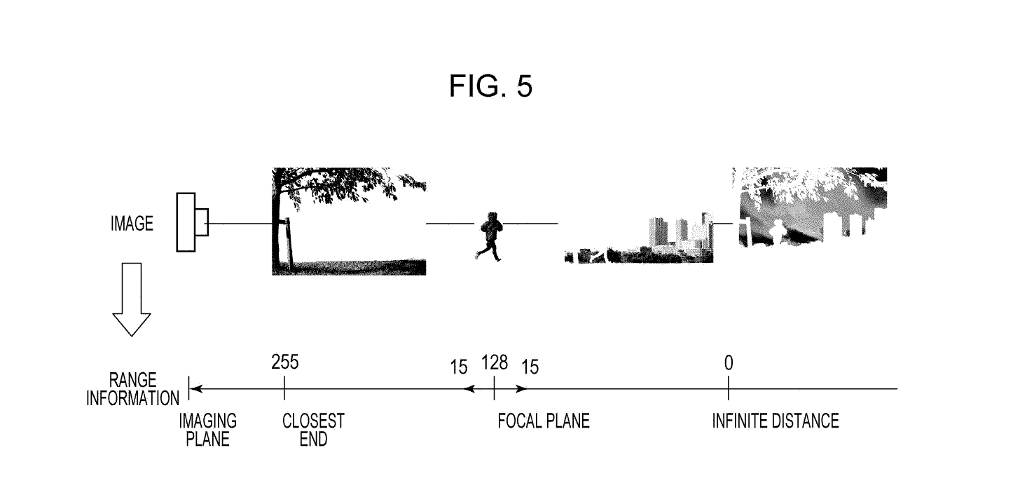

FIGS. 4A to 4F are image diagrams of images (data) subjected to the individual processes at the steps of the shadow-tone process performed by the shadow-tone processing unit 5 in the present embodiment. FIG. 4A illustrates a sample of image data, which is YUV data output from the development processing unit 4 and input to the shadow-tone processing unit 5. FIG. 5 is a schematic diagram illustrating the relationship between the objects in the image data and the distances. As illustrated in FIG. 4A and FIG. 5, the image data contains a person, or the main object, at the center of the screen on the focal plane, a tree trunk standing on the left side of the screen at the closest end, a group of buildings and woods far from the focal plane, and the sky at the infinite distance.

FIG. 4B is an image diagram of the range information output from the range-information acquisition unit 12 and input to the shadow-tone processing unit 5. In FIG. 4B, the value of the sky at the infinite distance is 0, the value of the buildings and woods far from the focal plane is 64, the value of the person at the focal plane is 128, the value of the tree trunk at the closest end is 255, and the value of the ground between the person and the tree changes continuously between 128 and 255. FIG. 4B illustrates an image in white and black monotone according to the above values.

FIG. 4C is an image diagram of image data output from the gradation assigning unit 201. In FIG. 4C, the values of the tree and the ground whose values of range information are greater than the value at the focal plane become uniformly 0 by the gradation assigning process described above, so that the tree and the ground are expressed like a shadow in which their silhouettes are emphasized, while the person is expressed in a half tone of 100, so that the silhouette of the tree and the silhouette of the person can be clearly distinguished. The values of the group of buildings and the woods whose values of range information are less than the value at the focal plane become uniformly 200, so that they can be distinguished from the shadow and the areas of the person while their silhouettes are emphasized. The value of the sky at the infinite distance is uniformly 220, so that the sky is brightest in the screen and is expressed like a screen in the shadow picture.

FIG. 4D is an image diagram of image data output from the combining unit 203. In the present embodiment, the area whose range information is the infinite distance in the image output from the gradation assigning unit 201 is replaces with the blurred image output from the blurred-image generating unit 202. FIG. 4D shows that the sharpness of the outlines of the group of buildings and the woods is decreased, while the sharpness of the outline of the shadow is kept high, so that the silhouette of the shadow is emphasized.

FIG. 4E is an image diagram of image data output from the marginal-illumination decreasing processing unit 204. In the present embodiment, the marginal-illumination decreasing process is performed by multiplying the image data output from the blurred-image generating unit 202 by marginal-illumination decreasing data that concentrically decreases the input value at a predetermined ratio from 100% of the center of the screen to 30% at the four corners of the screen. FIG. 4E shows that a decrease in marginal illumination like a screen irradiated with a point light source is expressed.

As described above, in the final image acquired by performing the gradation assigning process using the characteristics as in the LUT 207a of FIG. 3A, the tree trunk is expressed like a shadow, and the person is expressed in half tone, so that the silhouette of the tree and the silhouette of the person can be clearly distinguished.

However, this final image also has an aspect of being different from the characteristic gradations of a shadow picture that the main object, in particular, a person, is expressed as a shadow. For that reason, it is ideal to be able to select control to separate the gradation of the main object and the gradation of an object nearer to the imaging plane than the main object depending on the user's intension of drawing and whether a person is present. In the present embodiment, a suitable LUT is selected for application according to the user's intension of drawing and whether a person is present.

FIGS. 6A to 6D are flowcharts illustrating the overall operation of the shadow-tone process performed by the shadow-tone processing unit 5 illustrated in FIG. 2. The operations of the flowcharts are performed by the control unit 10 or by the components according to instructions of the control unit 10.

At step S601, the LUT selecting unit 206 selects and sets a LUT 208 to be used by the gradation assigning unit 201.

At step S602, the gradation assigning unit 201 performs the gradation assigning process as described above according to the selected LUT 208.

At step S603, the blurred-image generating unit 202 performs the blurred-image generating process on the image data to which gradations are assigned.

At step S604, the combining unit 203 performs the combining process on the blurred image output from the blurred-image generating unit 202 and the image data output from the gradation assigning unit 201, as described above.

At step S605, the marginal-illumination decreasing processing unit 204 performs the marginal-illumination decreasing process on the combined image data.

At step S606, the representative-color selecting unit 209 selects representative-color information for toning the shadow-tone image.

At step S607, the toning unit 205 creates chrominance (UV) data on the shadow-tone image using the luminance (Y) data subjected to the marginal-illumination decreasing process and the representative-color information. The shadow-tone processing unit 5 outputs YUV-image data in which the chrominance (UV) data and the luminance (Y) data output from the marginal-illumination decreasing processing unit 204 are combined and terminates the process.

The LUT selecting process at step S601 in FIG. 6A will be described in detail with reference to the flowchart of FIG. 6B. As described above, the present embodiment selects a suitable LUT for application depending on user's intention of drawing and whether a person is present.

For example, in the case where the user's intention of drawing is to reliably discriminate the silhouette of the main object on the focal plane, the gradation assigning unit 201 assigns gradations using the LUT 1 having the characteristic of assigning 0 to the closest end, and a value greater than 0 to the main object, as illustrated in FIG. 3A. In the case where the user's intention of drawing is to express the main object as a shadow like a shadow picture, the gradation assigning unit 201 assigns gradations using a LUT 2 having the characteristic of uniformly assigning a gradation value 0 to objects between the main object at the focal plane and the closest end, as illustrated in FIG. 3B.

However, both of the LUTs 1 and 2 have the characteristic of assigning a gradation value 220 to an object at the infinite distance to express the object as a screen. Objects between the infinite distance and the main object are assigned a gradation value 200 so as to be expressed as a distant view. As described above, FIG. 4E illustrates an image output from the shadow-tone processing unit 5 when the LUT 1 is used as the LUT 208 by the gradation assigning unit 201. FIG. 4F illustrates an output image when the LUT 2 is used as the LUT 208. Referring to FIG. 4F, the gradation value of the main object at the focal plane is 0, so that the main object is always expressed as a shadow, producing an expression close to an actual shadow picture.

For example, in the case where the main object at the focal plane is a person, a gradation is assigned using the LUT 2 having the characteristic of expressing a person as a shadow. For determination of a person, a face detecting process and a human-body detecting process are performed on an area within a certain distance from the focal plane in the input image, and the results thereof are used. The face detecting process and the human-body detecting process may be performed using a known technique. The result of person determination is stored in the memory 11.

In the present embodiment, the user can select a shadow-tone kind before creating a shadow-tone image from among a mode of giving priority to shadow likeness, a mode of giving priority to silhouette discrimination, and a person determination priority mode of automatically switching between the shadow likeness priority mode and the silhouette discrimination priority mode according to the result of person determination on the main object. The shadow-tone kind input by the user via the UI unit 9 is stored in the memory 11.

At step S6011, the control unit 10 reads the shadow-tone kind, for example, person determination priority, from the memory 11.

At step S6012, the control unit 10 reads the result of person determination from the memory 11.

Next, at step S6013, the LUT selecting unit 206 selects a corresponding LUT 208 from the LUTs 207 of individual shadow-tone kinds stored in the memory 11 using the read shadow-tone kind and person determination result. The LUT selecting unit 206 selects the LUT 1 in the case of the mode giving priority to shadow likeness among the above shadow-tone kinds, the LUT 2 in the case of the mode giving priority to silhouette discrimination, the LUT 1 in the case of the mode giving priority to person determination, and the LUT 1 in the case of the result that a person is present, and the LUT 2 in the case of the result of that no person is present.

Storing the LUTs 207 for the individual shadow-tone kinds in advance eliminates the need for enormous calculation processing during photographing. This enables high-speed continuous shooting of still images without decreasing shooting frame speed and generation of high-resolution high-frame-rate moving images.

At step S6014, the control unit 10 sets the selected LUT 208 for the gradation assigning unit 201 and returns to the shadow-tone process.

The blurred-image generating process at step S603 of FIG. 6A will be described using the flowchart of FIG. 6C. In the blurred-image generating process, a blurred image is generated by combining the reducing process and the enlarging process, as described above. More specifically, the image can be blurred by decreasing the information volume by the reducing process and then enlarging the image with interpolation. First, the reduction size of a minimum image is set according to the target blur size.

In the present embodiment, for example, the size of a blurred image in which the infinite distance area is replaced is set to one fourth on each side (the number of pixels is one fourth in length and width) of the size of the input image. To reduce the input image to one fourth on each side, reduction to one half in length and width is repeated N times (N=2) (steps S6021 to 6024). To prevent folding of high-frequency components, that is, moire, due to the reduction, a low pass filter (LPF) with a filter factor [1, 2, 1] is applied in length and width to smooth the image before the reduction (step S6022). After completion of N times of reduction process, the image is enlarged to the original size. The enlarging process is also repeated N times to twofold in length and width, as in the reducing process (steps S6025 to 6027). In the present embodiment, the scaling ratio at one reduction is set to one half. However, the scaling ratio may be one fourth and is not limited thereto. Note that the filter factor of the low pass filter applied at that time is changed as appropriate to prevent generation of moire. For example, the filter factor in the case of one fourth is set to [1, 4, 6, 4, 1].

The representative-color selecting process at step S606 of FIG. 6A will be described in detail with reference to the flowchart in FIG. 6D. In the representative-color selecting process, representative-color information corresponding to the color film in an actual shadow picture is selected, as described above. In the actual shadow picture, the producer can express various scenes by selecting the color of the color film.

The actual scene, for example, a sunset view in a word, varies in brightness, hue, and saturation and is not uniform, but colors that recall an evening view are limited. Therefore, the colors are used in expression that inflates the imagination of the viewers with less information like shadow pictures. For that reason, for example, an orange film is often used for evening scenery, a water color film for blue sky scenery, and a green film for woods scenery. The most characteristic scene is a night sky. The actual night sky begins from dim light directly after sunset and shifts to twilight and then a dark night sky. In shadow pictures, colors other than shadows cannot be expressed in black, and the night sky is often expressed in slightly bright blue.

To give this characteristic to image data, the present embodiment stores color information matching representative scenes for use in shadow pictures in advance in the memory 11 in the form of YUV data, and the representative-color selecting unit 209 selects the color information. When expressing an evening scene, the representative-color selecting unit 209 selects color information 210a as representative-color information 211, and when expressing a blue sky scene, a night sky scene, and a green-of-trees scene, the representative-color selecting unit 209 respectively selects color information 210b, color information 210c, and color information 210d.

Which scene is to be expressed is determined by the representative-color selecting unit 209 using, for example, color specification information input from the user, range information, photographic information, and input image data. The color specification information input by the user via the UI unit 9 is stored in the memory 11.

At step S6031, the control unit 10 reads the color specification information from the memory 11. In the present embodiment, the color specification information can be selected from “no color is specified”, “color is specified”, “color is specified (black and white)”, “color is specified (evening view)”, “color is specified (blue sky)”, “color is specified (night sky)”, and “color is specified (green of trees)”.

At step S6032, the representative-color selecting unit 209 makes a determination on the color specification information read from the memory 11. If the determination is “color is specified”, the representative-color selecting unit 209 reads the specified representative-color information from the memory 11, outputs it to the toning unit 205, and goes to step S6036. If the determination is “no color is specified”, the process goes to step S6033.

At step S6033, the representative-color selecting unit 209 reads photographic information from the range-information acquisition unit 12. Examples of the photographic information In the present embodiment include photographed-scene determination information calculated from the input image, (auto-white balance) AWB calculation information calculated from the input image, and infrared-sensor output information acquired from an infrared sensor (not shown).

At step S6034, the representative-color selecting unit 209 reads range information corresponding to the input image from the range-information acquisition unit 12.

At step S6035, the representative-color selecting unit 209 selects representative-color information using the photographic information and the range information described above. In the case where the above scene determination result is obtained as the photographic information, for example, evening view determination, the representative-color selecting unit 209 selects the color information 210a as the representative-color information 211, and in the case of night view determination, the representative-color selecting unit 209 selects the color information 210c. In the case where the scene determination result is landscape, it is impossible to determine which of 210b and 210d is optimum. In actual shadow pictures, an object closer to the viewer is expressed as a shadow, and therefore an object to be toned using a color film is mainly the background. To give this characteristic to the image data, in the present embodiment, the representative-color selecting unit 209 specifies the background (a background area) of the input image using the range information and selects color information close to the color information on the background as the representative-color information 211. For example, the mean values of Y, U, and V of the background are respectively 211, 21, and −23, the value of hue when the YUV space is converted to a HSV (hue, saturation, value) space is 204°, which is close to the hue of sky blue, and therefore 210b indicating a blue sky is selected as the representative-color information 211. An area whose distance is larger than a predetermined value can be set as a ground area on the basis of the range information.

At step S6036, the control unit 10 sets the selected representative-color information 211 for the toning unit 205.

Although the present embodiment is configured such that, only when color specification information is not input by the user (NO at S6032) on the assumption that color is to be specified by the user, the representative-color selecting unit 209 selects representative-color information on the basis of the photographic information on the input image, this is not intended to limit the present disclosure. The present disclosure may be configured such that the representative-color selecting unit 209 selects a representative color on the basis of the photographic information on the input image regardless of whether color specification information is input by the user.

Furthermore, although the present embodiment is configured such that the representative-color selecting unit 209 selects a representative color from a plurality of colors prepared in advance, a representative color may be extracted from the input image for setting.

The toning process at step S607 of FIG. 6A will be described in detail. The toning unit 205 generates a chrominance (UV) signal for a shadow-tone image using the representative-color information input from the representative-color selecting unit 209 and the luminance (Y) data subjected to the marginal-illumination decreasing process, which is input from the marginal-illumination decreasing processing unit 204. The representative-color information selected at step S6035 is YUV data indicating a blue sky. For example, if the UV value is uniformly assigned to the chrominance (UV) signal for the shadow-tone image, the shadow portion is also colored, generating an unnatural shadow-tone image.

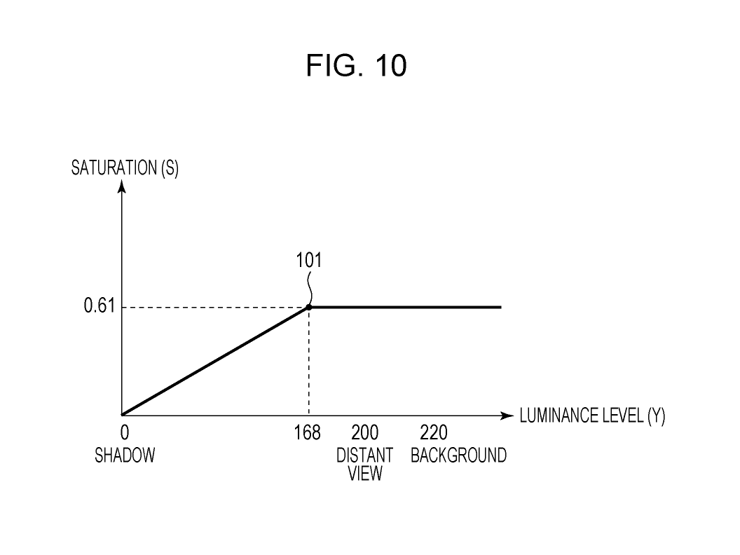

For that reason, the present embodiment reduces the saturation of the representative-color information according to the luminance (Y) data subjected to the marginal-illumination decreasing process and assigns the UV data to the chrominance (UV) signal for the shadow-tone image. FIG. 10 is a graph showing the relationship between the luminance (Y) data subjected to the marginal-illumination decreasing process and the saturation of the shadow-tone image. A point 101 indicates the representative-color information 211 selected at step S6035. In the present embodiment, the luminance (Y) is 168, and saturation (S) is 0.61. The saturation of the shadow-tone image decreases as the luminance (Y) decreases with reference to the representative-color information 211 and reaches 0 when the luminance (Y) reaches 0. In contrast, even if the luminance (Y) become higher than 168, the saturation (S) is clipped at 0.61, so that the saturation does not increase unnaturally.

Thus, in the shadow-tone process for giving a shadow-tone effect, the present embodiment creates a shadow-tone image by generating luminance data having shadow tone gradations using range information corresponding to the input image and combining the luminance data with color data toned using representative-color information prepared in advance into final image data. Thus, a shadow-tone process for drawing the background in rich color in which the atmosphere of the input image remains and expressing the main object in back or gray shadow can be achieved.

### Second Embodiment

Since a background in a shadow picture is a screen in which no object is present, the luminance (Y) and the chrominance (UV) have uniform values across the background except an area in which a decrease in marginal illumination of a light source projecting the shadow picture light occurs. Since the background has a large area, a flat impression may be given particularly when toning using a color film is performed. To prevent it, there is a method of adding a texture only to the background by disposing, for example, several sheets of thin paper that transit light, between the light source and the object that forms a shadow.

Although the first embodiment uses a LUT having the characteristic of assigning the same luminance (Y) and chrominance (UV) uniformly across the background when assigning gradations with the gradation assigning unit 201, a second embodiment uses a LUT for assigning luminance (Y) data on the original image to the luminance (Y) data on the background.

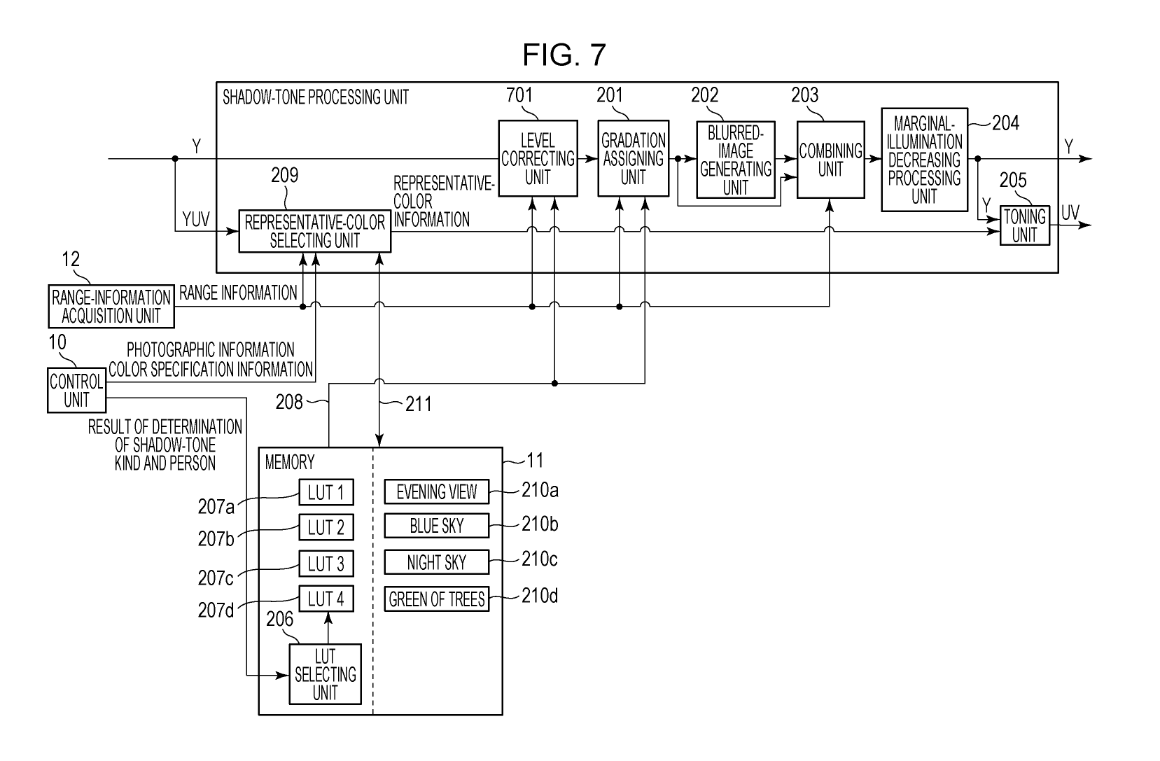

FIG. 7 is a block diagram illustrating the details of a shadow-tone processing unit 5 in the second embodiment. The blocks given the same reference signs as those in FIG. 2 are the same in processing details, and descriptions thereof will be omitted. Difference from the first embodiment is that a level correcting unit 701 is provided, and the level correcting unit 701 analyzes the range information and the LUT 208 and corrects the level of the luminance (Y) data on the input image as need arises.

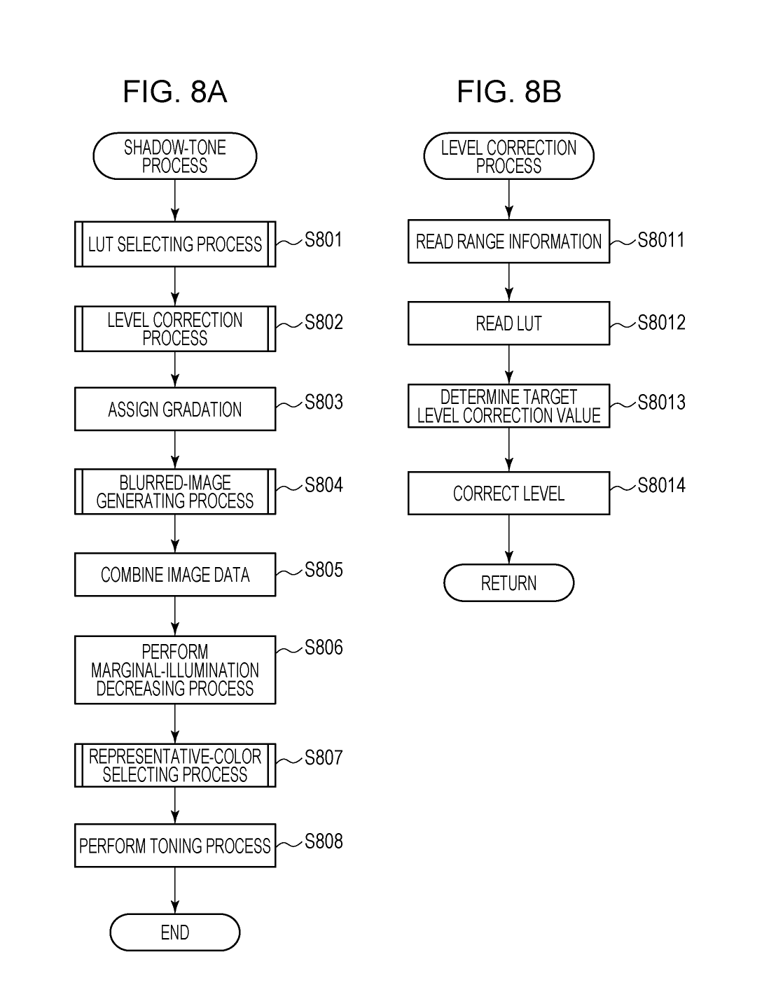

FIGS. 8A and 8B are flowcharts illustrating the overall operations of a shadow-tone process performed by the shadow-tone processing unit 5 illustrated in FIG. 7 in the present embodiment. The shadow-tone process is the same as the process in FIGS. 6A to 6D except step S801 and step S802.

Although the operation at step S801 is similar to that of step S601, the present embodiment selects a LUT for assigning the luminance (Y) data on the original image to the luminance (Y) data on the background and uses the LUT, as described above. FIG. 3C illustrates a LUT 3 in which the characteristic of the LUT 2 used in the first embodiment is changed to give the luminance (Y) data on the input image to an object at the infinite distance.

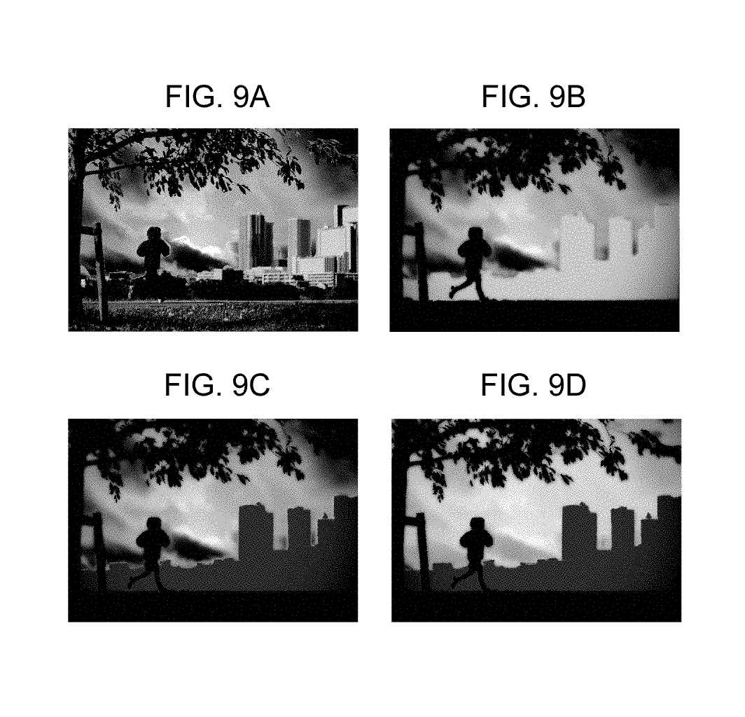

FIGS. 9A to 9D are image diagrams of images (data) subjected to the individual processes at the steps of the shadow-tone process performed by the shadow-tone processing unit 5 in the present embodiment. FIG. 9A illustrates a sample of image data, which is YUV data output from the development processing unit 4 and input to the shadow-tone processing unit 5. FIG. 9B is an image diagram of image data output from the shadow-tone processing unit 5 when the LUT 3 is selected at step S801. Referring to FIG. 9B, the luminance (Y) data of the background has become data subjected to the blurring process and the marginal-illumination decreasing process on the luminance (Y) data of the input image, in which the flat impression of the background can be eliminated. In contrast, when compared with FIG. 4F in which the gradation value 220 is uniformly assigned to the background, FIG. 9B has a part darker than the group of buildings of the distant area in the background and is out of the characteristic gradations of shadow pictures that an object farther to the viewer is brighter than an object closer to the viewer.

FIG. 3D illustrates the characteristic of a LUT 4 in which a value obtained by multiplying the mean value of the luminance (Y) of the background by 0.5 is assigned to the distant area located between the main object and the background. FIG. 9C is an image diagram of image data output from the shadow-tone processing unit 5 when the LUT 4 is selected at step S801. Since the mean value of the luminance (Y) of the background is 168, the distant area is assigned half thereof, 84.

A comparison of FIG. 9C with FIG. 9B shows that the luminance (Y) of the group of buildings in the distant area has decreased, but the luminance (Y) of the background vary widely, for example, the luminance (Y) of the darkest pixels is 53, so that a wide background area darker than the distant area remains. At step S801, the process of lowering the luminance (Y) of the distant area than the luminance (Y) of the background. However, when the wide range of variation in the luminance (Y) of the background makes the whole image dark, and therefore it is impossible to lower the luminance (Y) of the distant area than the luminance (Y) of the background. For that reason, a level correcting process for increasing the luminance (Y) of the background is performed at step S802.

At step S802, the level correcting unit 701 corrects the level of the luminance (Y) data in the input image.

At steps S803 to S808, the same operations as those of steps S602 to S607 are performed, and the shadow-tone process ends.

The level correcting process at step S802 of FIG. 8A will be described with reference to the flowchart of FIG. 8B. As described above, in the present embodiment, the level of the luminance (Y) data on the input image is corrected.

The present embodiment performs a level correcting process for making the darkest pixels of the background twice the brightness of the distant area to ensure that the background seems to be brighter than the distant area. For example, a level correcting process for making the range of the luminance (Y) of 53 to 255 to the range of 168 to 255. FIG. 9D is an image diagram of image data output from the shadow-tone processing unit 5 when the level of the luminance (Y) of the input image is corrected at step S802. FIG. 9D shows that all of the pixels of the background have become brighter than the group of buildings of the distant area, which matches the characteristic gradations of shadow pictures.

At step S8011, the level correcting unit 701 reads range information corresponding to the input image from the range-information acquisition unit 12.

At step S8012, the level correcting unit 701 reads the LUT 208 from the memory 11. For the LUT 208, the result selected by the LUT selecting unit 206 at step S801 is used.

At step S8013, the level correcting unit 701 determines a target level correction value using the range information and the LUT 208. The level correcting unit 701 first specifies a background in the input image with reference to the range information and determines that the luminance (Y) of the darkest pixels is 53 with reference to the background. Next, the level correcting unit 701 determines the mean value of the luminance (Y) data on the background. Finally, the level correcting unit 701 calculates a gradation value to be assigned to the distant area with reference to the LUT 208. Since the present embodiment uses the LUT 4 illustrated in FIG. 3D as the LUT 208, the gradation value of the distant area is half of the mean value of the luminance (Y) of the background, that is, 84. Since the objective of the level correction in the present embodiment is, for example, to make the brightness of the darkest pixels of the background twice the brightness of the distant area, as described above, a target level correction value is set to the range of 168 to 255 to correct the range of 53 to 255.

Thus, in the shadow-tone process for giving a shadow-tone effect, the present embodiment creates a shadow-tone image by generating luminance data having shadow tone gradations using range information corresponding to the input image and combining the luminance data with color data toned using representative-color information prepared in advance into final image data. Thus, a shadow-tone process for drawing the background in rich color in which the atmosphere of the input image remains and expressing the main object in back or gray shadow can be achieved.

Furthermore, the present embodiment can create a shadow-tone image which is drawn in rich color and in which the atmosphere of the photographed scene remains without giving a flat impression even if the image is toned by correcting the level of the gradations of the input image according to the LUT used and using the corrected data as the luminance data for the background.

Although the above embodiments have also been described as related to the hardware configuration of the individual blocks of the shadow-tone processing unit 5, the operations of the blocks can also be implemented by software, so that part or all of the operations of the shadow-tone processing unit 5 may be implemented by software processing. Furthermore, part or all of the other blocks of the image processing apparatus 100 in FIG. 1 may be implemented by software processing.

In the above embodiments, the gradation assignment in the gradation assigning unit 201 is performed using a one-dimensional LUT. However, the method of gradation assigning processing is given for mere illustration. Any other method of gradation assignment with the characteristics as illustrated in FIGS. 3A to 3D may be employed, for example, a process of calculating output pixel values by performing calculation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors and one or more memories (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2016-143698 filed Jul. 21, 2016, which is hereby incorporated by reference herein in its entirety.

What is claimed is:

1. An image processing apparatus comprising:
a range-information acquisition unit configured to acquire range information on an input image;
a gradation assigning unit configured to assign a gradation to each area of the input image using the range information and to convert luminance data on the input image according to the assigned gradation;
a representative-color setting unit configured to set a representative color; and
a toning unit configured to convert color data on the input image according to the representative color.

2. The image processing apparatus according to claim 1, wherein the representative-color setting unit sets the representative color based on image data on a background area in the input image.

3. The image processing apparatus according to claim 1, wherein the representative-color setting unit sets the representative color based on photographic information on the input image.

4. The image processing apparatus according to claim 1, wherein the photographic information comprises at least one of AWB (auto-white balance) calculation information, photographed-scene determination information, and infrared-sensor output information.

5. The image processing apparatus according to claim 1, wherein the toning unit converts the color data on the input image according to color data in which saturation of the representative color is lowered using the luminance data on the input image.

6. The image processing apparatus according to claim 1, wherein, when a person is detected in the input image, the gradation assigning unit assigns a luminance of 0 to an area in which the detected person is present and an area within a certain distance from the area.

7. The image processing apparatus according to claim 1, wherein the gradation assigning unit assigns the luminance data on the input image to a background area in the input image.

8. The image processing apparatus according to claim 7, further comprising:
a level correction unit configured to correct a level of luminance data on the input image,
wherein the gradation assigning unit assigns data in which the level of the luminance data on the input image is corrected to at least part of the background area in the input image.

9. The image processing apparatus according to claim 1, further comprising:
a blurred-image generating unit configured to form a blurred image by performing a blurring process for smoothing the luminance data output from the gradation assigning unit; and
a combining unit configured to combine the luminance data output from the gradation assigning unit with luminance data on the blurred image,
wherein, for a background area in the input image, the combining unit combines the image data with the luminance data on the blurred image, and for an area whose distance is smaller than a specified value, the combining unit combines the image data with the luminance data output from the gradation assigning unit.

10. A method for processing an image, the method comprising:
acquiring range information on an input image;
assigning a gradation to each area of the input image using the range information and converting luminance data on the input image according to the assigned gradation;
setting a representative color; and
converting color data on the input image according to the representative color.

11. A computer readable storage medium storing a program for causing a computer to execute a method comprising:
acquiring range information on an input image;
assigning a gradation to each area of the input image using the range information and converting luminance data on the input image according to the assigned gradation;
setting a representative color; and
converting color data on the input image according to the representative color.
